(19) United States
(12) Patent Application Publication
(10) Pub. No.: US 2014/0267891 A1
(43) Pub. Date: Sep. 18, 2014

(54) MOBILE DEVICE CAMERA ENCLOSURE WITH IMAGING SENSOR

(71) Applicant: William Adams, Los Angeles, CA (US)

(72) Inventor: William Adams, Los Angeles, CA (US)

(21) Appl. No.: 14/209,649

(22) Filed: Mar. 13, 2014

Related U.S. Application Data
(60) Provisional application No. 61/785,002, filed on Mar. 14, 2013.

(51) Int. Cl. H04N 5/225

(52) U.S. Cl. CPC H04N 5/2254
USPC 348/373

(57) ABSTRACT

A mobile computing device camera enclosure. The enclosure includes a digital imaging sensor and a camera lens mount that optically aligns a camera lens over the digital imaging sensor. The enclosure also includes an attachment mechanism for securing a mobile computing device and a communications interface for communicating with an attached mobile computing device. A camera system includes a camera lens and a camera enclosure. The camera enclosure includes a digital imaging sensor and a camera lens mount that optically aligns the camera lens over the digital imaging sensor. The camera enclosure also includes an attachment mechanism for securing a multi-purpose mobile computing device within the camera enclosure and a communications interface for communicating with the multi-purpose mobile computing device.

### CROSS-REFERENCE TO RELATED APPLICATIONS

This application is a non-provisional of, and claims priority to and the benefit of, U.S. Provisional Application Ser. No. 61/785,002 filed on Mar. 14, 2013 and entitled “MOBILE DEVICE CAMERA ENCLOSURE WITH IMAGING SENSOR.” The entire contents of the foregoing provisional application are hereby expressly incorporated herein by this reference in their entirety.

### BACKGROUND

The recent proliferation of mobile computing devices, such as smartphones, digital media players, and tablet computers has been astounding. Mobile computing devices have become an integral part of modern life, and are now possessed by a significant portion of the population. As mobile computing devices have evolved, they have become capable of performing significant computing tasks, such as image and video processing/editing, the capture of digital images and movies, and the communication of digital images and movies to other electronic devices.

As the computing and imaging abilities of mobile computing devices have evolved, mobile computing devices have been able to become a primary device for a variety of functions, including media production and consumption, electronic communications, productivity, photography, etc. Since a single mobile computing device can duplicate the functionality of several dedicated devices, users have been able to reduce the number of devices they carry with them—and frequently down to a single mobile computing device. However, while mobile computing devices are very usable for many situations, it may be desirable at times to have visual aesthetics and/or functionality more comparable to a dedicated device.

### BRIEF SUMMARY

The present invention extends to mobile device enclosures that enhance the image capture abilities of mobile devices and that improve the user experience when using a mobile computing device as a camera (either for still image or for video capture). More particularly, the present invention extends to mobile device camera enclosures that provide image sensors and that enable the capture of professional-level digital images and/or movies with mobile computing devices. Mobile device camera enclosures according to embodiments of the present invention can enable use of a variety of different camera lenses, and can have a visual appearance/aesthetic and corresponding functionality/capabilities that reflects a more traditional digital camera (e.g., point and shoot, single lens reflex, etc.).

One or more embodiments include a mobile computing device camera enclosure that is configured to removably attach to a mobile computing device. Mobile computing device camera enclosures according to embodiments herein include a digital imaging sensor and a camera lens mount that is configured to optically align a camera lens with the digital imaging sensor. Mobile computing device camera enclosures according to embodiments herein also include a mobile computing device attachment mechanism and one or more communications interfaces that are configured to communicate with an attached mobile computing device.

One or more embodiments also include a camera system that includes a multi-purpose mobile computing device, a camera lens, and a camera enclosure. The camera enclosure includes a digital imaging sensor and a camera lens mount that is configured to optically align the camera lens with the digital imaging sensor. The camera enclosure also includes a mobile computing device attachment mechanism that is configured to secure the multi-purpose mobile computing device within the camera enclosure and one or more communications interfaces that are configured to communicate with the multi-purpose mobile computing device.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates front and back views of a mobile device camera enclosure, according to one or more embodiments of the present invention.

FIG. 2 illustrates front and back views of a mobile device camera enclosure that is attached to a mobile computing device, according to one or more embodiments of the present invention

FIG. 3 illustrates a front view of a mobile device camera enclosure, including an attached lens, according to one or more embodiments of the present invention.

FIG. 4 illustrates a front view of a mobile device camera enclosure, according to one or more embodiments of the present invention.

FIG. 5 illustrates side views of a mobile device camera enclosure, according to one or more embodiments of the present invention.

FIG. 6 illustrates top and bottom views of a mobile device camera enclosure, according to one or more embodiments of the present invention.

### DETAILED DESCRIPTION

The present invention extends to mobile device enclosures that enhance the image capture abilities of mobile devices and that improve the user experience when using a mobile computing device as a camera (either for still image or for video capture). More particularly, the present invention extends to mobile device camera enclosures that provide image sensors and that enable the capture of professional-level digital images and/or movies with mobile computing devices. Mobile device camera enclosures according to embodiments of the present invention can enable use of a variety of different camera lenses, and can have a visual appearance/aesthetic and corresponding functionality/capabilities that reflects a more traditional digital camera (e.g., point and shoot, single lens reflex, etc.).

Mobile computing devices according to embodiments of the present invention can include multi-purpose mobile computing devices, such as smartphones, digital media players, tablet computers, etc. As used herein, multi-purpose mobile computing devices include the ability to be repurposed for various functions. For example, multi-purpose mobile computing devices may include (and/or provide the ability to have installed thereon) a plurality of applications (apps) that, when executed, repurpose the multi-purpose mobile computing device for a variety of different functions. As such, mobile computing devices can comprise general-purpose computing devices that can be re-purposed for different particular functionality through the use of different apps. In some embodiments, mobile computing devices comprise mobile communications devices (e.g., cellular phones) that are also multi-purpose mobile computing devices (e.g., smartphones).

One or more embodiments of the present invention are directed to camera enclosures that provide or expand image capture capabilities of mobile computing devices. For example, embodiments of the present invention can include camera enclosures that include one or more digital imaging sensors. As such, camera enclosures according to embodiments of the present invention can provide digital imaging capabilities to a mobile computing device that has no image capture capabilities, by providing a digital imaging sensor. Alternatively, camera enclosures according to embodiments of the present invention can enhance the image capture capabilities of a mobile computing device that does have image capture capabilities, by providing a digital imaging sensor of superior capability (e.g., larger size, higher pixel density, higher quality, higher sensitivity, etc.) than an imaging sensor included in the mobile computing device.

One or more embodiments of the present invention are directed to camera enclosures that include an integrated camera lens, or that that provide a lens mount for attaching camera lenses to the camera enclosure. As such, camera enclosures according to embodiments of the present invention can further enhance the image capture capabilities of a mobile computing device by providing lens characteristics (e.g., lens quality, optical characteristics, focal length, aperture, optical zoom, focus capabilities, image stabilization, etc.) that are different from (an potentially superior to) a camera lens that is included in the mobile computing device. In addition, in embodiments that provide a lens mount, the present camera enclosures enable users to removably attach one or more of a variety of camera lenses, which can enable a user to select a camera lens that is suitable for particular photographic situations (e.g., fish-eye, zoom, telephoto, etc.).

Embodiments of the present invention are also directed enhancing a user's experience associated with using a mobile computing device for photography, by providing camera enclosures that aesthetically appear as a camera (e.g., point and shoot, SLR, etc.), and that include functional analogs to cameras. For example, camera enclosures according to embodiments of the present invention may include hardware or software mechanisms corresponding to shutter buttons, scene type selectors, shutter speed selectors, shooting mode selectors, aperture selectors, metering selectors, or any other buttons, switches, selectors, etc., that may appear on a traditional stand-alone camera. As such, camera enclosures according to embodiments of the present invention can enhance the user experience of using a mobile computing device for photography by providing a familiar, intuitive, and tactile user interface.

Embodiments of the present invention can also enhance a user's ability to interface with and use a mobile computing device, itself. For example, camera enclosures according to embodiments of the present invention may include one or more physical input device(s) not present in the mobile computing device. For example, camera enclosures can include a slide-out keyboard that enables a user to enter textual input to an attached mobile computing device using physical keys/buttons. Camera enclosures according to embodiments of the present invention, may also include supplemental hardware, such as one or more batteries, solar panels, etc., to provide power to an attached mobile computing device, thereby extending and/or replenishing battery life of the attached mobile computing device. Other supplemental hardware devices present in camera enclosures may include speakers, microphones, environmental sensors, etc.

Turning now to the drawings, FIG. 1 illustrates front and back views of a mobile device camera enclosure 100. As depicted, the mobile device camera enclosure 100 includes a camera lens mount 102 for removably attaching different camera lenses (e.g., camera lens 108) to the mobile device camera enclosure 100 over a digital imaging sensor 104. The digital imaging sensor 104 can comprise any appropriate imaging sensor technology, such as charge-coupled device (CCD), complementary metal-oxide semiconductor (CMOS), etc. The mobile device camera enclosure 100 (and/or an attached camera lens) can also include any appropriate lens release mechanism (e.g., button, switch, etc.), such as a lens release mechanism 128.

As further depicted, the mobile device camera enclosure 100 may include one or more connectors 106 (e.g., electrical contacts, optical interfaces, etc.) for communicating with an attached camera lens (e.g., camera lens 108), and to exchange data with the attached camera lens. As such, the connectors 106 can enable the mobile device camera enclosure 100 and/or the attached mobile computing device to communicate with the attached camera lens (e.g., uni-directionally or bi-directionally). For example, the connectors 106 can be used to communicate lens identifier information, lens state information (e.g., aperture, zoom level, focus data), etc. from an attached camera lens, and/or to communicate lens instructions (e.g., zoom instructions, focus instructions, aperture instructions, etc.) to an attached camera lens.

Furthermore, the camera lens mount 102 and/or the connectors 106 can be configured to accommodate camera lenses of different types. For example, the camera lens mount 102 and/or the connectors 106 may be configured to accommodate camera lenses produced from a variety of camera lens manufacturers (e.g., CANON, NIKON, OLYMPUS, MINOLTA, etc.). In some embodiments, the camera lens mount 102 and/or the electrical connectors 106 may be configured to be used in connection with one or more camera lens adapters (not depicted) that enable a variety of different camera lenses to interface with the camera lens mount 102 and/or the electrical connectors 106. The mobile device camera enclosure 100 may be configured to communicate with camera lenses using a variety of communications protocols, depending on the particular lens that is attached to the camera lens mount 102. As such, the mobile device camera enclosure 100 may be a universal mount for a great variety of camera lenses from different manufacturers.

With the combination of a professional-quality digital imaging sensor 104 and a lens having professional-level optics (e.g., SLR-type lenses that may typically be used in connection with a professional-level SLR camera), the mobile device camera enclosure 100 can enable a mobile computing device to capture images at a much higher quality than may be possible using the mobile computing device's own imaging hardware (e.g., integrated optics and sensor). As such, the mobile device camera enclosure 100 can enable professional-level image capture using mobile computing devices.

FIG. 1 also depicts that the mobile device camera enclosure 100 can include an enclosure bay 126 for housing any compatible mobile computing device. In the depicted embodiment, the mobile device camera enclosure 100 also includes a door 114 (including a window) for securing a mobile computing device within the enclosure bay 114. The door 114 can be configured to operate with one or more latching mechanisms for securing the door 114 in a closed position. The mobile device camera enclosure 100 may also include one or more mechanisms for opening the door 114, such as the depicted door switch 132. It will be appreciated that mobile computing devices may be secured within mobile device camera enclosures using means other than doors (e.g., friction, latches, brackets, etc.).

The mobile device camera enclosure 100 can include any appropriate communications interface for communicating with an attached mobile computing device, to exchange data with the attached mobile computing device. For example, although not depicted, the mobile device camera enclosure 100 may include one or more hard-wired connectors, such as UNIVERSAL SERIAL BUS, APPLE DOCK CONNECTOR, APPLE LIGHTNING, etc. In another example, the mobile device camera enclosure 100 may include one or more wireless communications interfaces, such as WIFI, BLUETOOTH, NEAR FIELD COMMUNICATIONS, etc. Regardless of the connection type used, the mobile device camera enclosure 100 can be configured to communicate uni-directionally or bi-directionally with an attached mobile computing device.

As indicted previously, the mobile device enclosure 100 can include one or more physical input devices that extend the input capabilities of an attached mobile computing device. As depicted, for example, the mobile device camera enclosure 100 can also include a slide-out keyboard 112 for providing textual input to an attached mobile computing device. The mobile device camera enclosure 100 can be configured to receive input at the slide-out keyboard 112, and to transfer the input to the attached mobile computing device through the communications interface(s) between the mobile device camera enclosure 100 and the attached mobile computing device. As depicted, the mobile device camera enclosure 100 may also include a keyboard release mechanism 120 for releasing the keyboard and permitting the keyboard to slide to the extended position along rails, grooves, etc. Other physical input devices may include d-pads, joysticks, touchpads, etc.

Although not specifically identified in FIG. 1, the mobile device camera enclosure 100 can include any appropriate camera control mechanism(s). For example, the mobile device camera enclosure 100 may include one or more power switches (e.g., switch 136), one or more shutter triggering mechanisms (e.g., shutter button 116), one or more selectors (e.g., dial 118), etc. It will be appreciated that camera control mechanisms can control camera functions, such as drive mode, aperture/exposure, focus, depth of field preview, etc. Additionally or alternatively, the mobile device camera enclosure 100 may also include one or more imaging related features, such as one or more flash devices (e.g., flash 110), one or more red-eye reduction lamps (e.g., lamp 124), one or more external flash interfaces (e.g., flash shoe 122), etc. The mobile device camera enclosure 100 may also include mounting and/or attaching mechanisms, such as a tripod mount 134, lanyard attachments (e.g., attachments 130a and 130b), etc.

Communication between the mobile device camera enclosure 100 and an attached mobile computing device can enable the capture of images (still and/or video) at the digital imaging sensor 104, and can enable transfer of the captured images to the attached mobile computing device. Communication between the mobile device camera enclosure 100 and an attached mobile computing device can enable the capture of audio at the mobile device camera enclosure 100, and enable transfer of the captured audio to the attached mobile computing device.

In some embodiments, the mobile device camera enclosure 100 includes computer hardware and/or software that orchestrates the capture and transfer of digital images. For example, computer hardware at the mobile device camera enclosure 100 may receive a trigger signal from a shutter triggering mechanism (e.g., the shutter button 116), initiate capture of one or more images at the digital imaging sensor 104, and transfer the captured image(s) to the attached mobile computing device. When performing image capture, the mobile device camera enclosure 100 may use settings (e.g., shutter speed, aperture, zoom level, flash instructions, etc.) that are specified by the attached mobile computing device, or that are specified via hardware mechanisms (e.g., buttons, switches, dials, etc. on the mobile device camera enclosure 100).

In some embodiments, the attached mobile computing device orchestrates the capture and transfer of digital images. For example, the mobile computing device can instruct the mobile device camera enclosure 100 to initiate capture of one or more images at the digital imaging sensor 104 (e.g., in response to actuation of the shutter button 116, in response to user input at the mobile computing device, and/or in response to an automatic instruction or trigger at the mobile computing device). The mobile computing device may also initiate transfer the captured image(s) from the mobile device camera enclosure 100 to the attached mobile computing device. When performing image capture, the mobile computing device may control hardware of the mobile device camera enclosure 100 directly to control shutter speed, aperture, zoom level, flash instructions, etc.

One of ordinary skill in the art will recognize that varying levels of cooperation between an attached mobile computing device and computer hardware included in the mobile device camera enclosure 100 are possible. As such, varying levels of control can occur at attached mobile computing device and varying levels of control can occur at computer hardware included in the mobile device camera enclosure 100. For example, at one end of the spectrum the mobile device camera enclosure 100 may, in some embodiments, include all hardware and software necessary to function independently of an attached mobile computing device. In another example, at the other end of the spectrum the mobile device camera enclosure 100 includes only enough hardware and/or software to respond provide input to the attached mobile computing device and to respond to commands from the attached mobile computing device, such that the attached mobile computing device preforms substantially all image processing and logic tasks.

Any level of cooperation between these two ends of the spectrum is also possible. For example, while the mobile device camera enclosure 100 may be largely controlled by the attached mobile computing device, the mobile device camera enclosure 100 include dedicated image and/or video processing hardware for encoding, decoding, and/or manipulating images and/or videos. As such, the mobile device camera enclosure 100 an offload processing intensive tasks from the attached mobile computing device, which can increase available resources at the mobile computing device and reduce power consumption of the mobile computing device (thereby increasing its battery life).

The mobile device camera enclosure 100 can include various other hardware features to enhance image capture capabilities and/or the integration between the mobile device camera enclosure 100 and an attached mobile computing device. For example, the mobile device camera enclosure 100 can include more than one imaging sensor and corresponding camera lenses and/or camera lens mounts. As such, the mobile device camera enclosure 100 can enable the capture of three-dimensional images and/or video.

In another example, the mobile device camera enclosure 100 can include one or more batteries, one or more solar panels, one or more kinetic energy devices, and/or one or more external electrical connections that can provide power to the attached mobile computing device. As such, the mobile device camera enclosure 100 can charge or otherwise increase battery life of the attached mobile computing device.

In yet another example, the mobile device camera enclosure 100 can provide water, shock, and extreme temperature resistance for an attached mobile computing device. For example, rather than providing a window, the door 114 can include a glass, membrane, plastic, or other transparent material that enables to the user to view and interact with an attached mobile computing device, while providing water protection for the attached mobile computing device.

In yet another example, the mobile device camera enclosure 100 can enable use of removable “skins” to aesthetically alter the appearance of the mobile device camera enclosure 100. As such, a user may be enabled to alter the appearance of the mobile device camera enclosure 100 over time my exchanging these skins.

In yet another example, the mobile device camera enclosure 100 can include additional storage and/or the ability to add external storage devices, expanding the amount of storage available to an attached mobile device. For example, the mobile device camera enclosure 100 may include one or more external USB interfaces, one or more SECURE DIGITAL (SD) card interfaces, one or more COMPACT FLASH (CF) interfaces, etc.

The remaining figures illustrate some additional views of mobile device camera enclosures according to embodiments of the present invention. FIG. 2, for example, illustrates additional front and back views of the mobile device camera enclosure 100. In particular, FIG. 2 illustrates the mobile device camera enclosure 100 of FIG. 1, including an attached mobile computing device 200 (in this case, a smartphone).

FIGS. 3 and 4 illustrate additional front views of the mobile device camera enclosure 100. In FIG. 3, the mobile device camera enclosure 100 is shown with an attached lens 108. In FIG. 4, the mobile device camera enclosure 100 is shown without a lens.

FIG. 5 illustrates side views of the mobile device camera enclosure 100, while FIG. 6 illustrates top and bottom views of the mobile device camera 100 enclosure.

The embodiments described herein can enhance the user experience of using a mobile computing device to take photos, and can greatly enhance the photographic capabilities of mobile computing devices. In addition, the embodiments described herein can provide increase aesthetics by making a mobile computing device appear as a traditional camera, and by providing familiar and tactile photographic controls.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media includes recordable-type storage devices, such as RAM, ROM, EEPROM, solid state drives (“SSDs”), flash memory, phase-change memory (“PCM”), optical disk storage, magnetic disk storage or other magnetic storage devices, or any other physical storage medium which can be used to store program code in the form of computer-executable instructions or data structures, and which can be accessed by a general-purpose or special-purpose computer system.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A mobile computing device camera enclosure that is configured to attach to a mobile computing device, the mobile computing device camera enclosure comprising:
a digital imaging sensor;
a camera lens mount that is configured to optically align a camera lens with the digital imaging sensor;
a mobile computing device attachment mechanism that is configured to secure a mobile computing device to the mobile computing device camera enclosure; and
one or more communications interfaces that are configured to exchange data with the computing device.

2. The mobile computing device camera enclosure as recited in claim 1, wherein the one or more communications interfaces comprise a hard-wired communications interface.

3. The mobile computing device camera enclosure as recited in claim 1, wherein the one or more communications interfaces comprise a wireless communications interface.

4. The mobile computing device camera enclosure as recited in claim 1, wherein the camera lens mount is configured to removably attach to one of a plurality of different camera lenses.

5. The mobile computing device camera enclosure as recited in claim 1, wherein the camera lens mount includes a communications mechanism for exchanging data with an attached lens.

6. The mobile computing device camera enclosure as recited in claim 1, further comprising a shutter triggering mechanism, wherein activation of the shutter mechanism causes the mobile computing device camera enclosure to capture a digital image at the digital imaging sensor and to transfer the image to the attached mobile computing device over the one or more communications interfaces.

7. The mobile computing device camera enclosure as recited in claim 1, further comprising a slide-out keyboard that is configured to provide textual input information to the mobile computing device over the one or more communications interfaces.

8. The mobile computing device camera enclosure as recited in claim 1, further comprising a door that is configured to secure the attached mobile computing device within the mobile device camera enclosure.

9. The mobile computing device camera enclosure as recited in claim 1, wherein activation of a shutter mechanism at the mobile computing device camera enclosure causes the mobile computing device camera enclosure to capture a digital image at the digital imaging sensor and to transfer the image to the mobile computing device over the one or more communications interfaces.

10. The mobile computing device camera enclosure as recited in claim 1, wherein activation of a shutter mechanism causes the mobile computing device camera enclosure to send a command to the mobile computing device over the one or more communications interfaces, the command instructing the mobile computing device to initiate capture of a digital image with the digital imaging sensor.

11. A camera system, comprising:
a camera lens; and
a camera enclosure, the camera enclosure including:
a digital imaging sensor;
a camera lens mount that is configured to optically align the camera lens with the digital imaging sensor;
a mobile computing device attachment mechanism that is configured to secure a multi-purpose mobile computing device within the camera enclosure; and
one or more communications interfaces that are configured to communicate with the multi-purpose mobile computing device.

12. The camera system as recited in claim 11, wherein the multi-purpose mobile computing device also includes an integrated camera.

13. The camera system as recited in claim 11, wherein the camera enclosure is configured to communicate a digital image acquired with the digital imaging sensor to the multi-purpose mobile computing device over the one or more communications interfaces.

14. The camera system as recited in claim 11, wherein the camera enclosure includes a slide-out keyboard.

15. The camera system as recited in claim 11, wherein the camera enclosure includes a door that secures the multi-purpose mobile computing device within the camera enclosure.

16. The camera system as recited in claim 11, wherein the multi-purpose mobile computing device comprises a smartphone.

17. The camera system as recited in claim 11, wherein the multi-purpose mobile computing device comprises a media device.

18. The camera system as recited in claim 11, wherein the multi-purpose mobile computing device comprises a tablet computer.

19. The camera system as recited in claim 11, wherein camera enclosure aesthetically appears as a point and shoot camera or a single lens reflex camera.

20. A camera system, comprising:
a camera lens; and
a camera enclosure, the camera enclosure including:
a digital imaging sensor;
a camera lens mount that is configured to optically align the camera lens with the digital imaging sensor;
a slide-out keyboard;
a battery that is configured to provide power to the multi-purpose mobile computing device;
a mobile computing device attachment mechanism that is configured to secure a multi-purpose mobile computing device within the camera enclosure; and
one or more communications interfaces that are configured to communicate with the multi-purpose mobile computing device.
